(19) United States
(12) Patent Application Publication
(10) Pub. No.: US 2007/0203319 A1
(43) Pub. Date: Aug. 30, 2007

(54) PROCESS OF FORMING A POLYOL

(76) Inventors: Edward M. Dexheimer, Grosse Ile, MI (US); Mao-Yao Huang, Riverview, MI (US); Thomas H. Plegue, Grosse Ile, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 11/276,370

(22) Filed: Feb. 27, 2006

(51) Int. Cl. C08G 18/00

(52) U.S. Cl. 528/44

(57) ABSTRACT

A process of forming a polyol includes the step of providing an initiator composition. The initiator composition includes sucrose as a first initiator and glycerin as a second initiator. The process also includes the steps of providing a dimethylalkanolamine and providing an alkylene oxide. The process further includes the step of reacting the initiator composition, the dimethylalkanolamine, and the alkylene oxide at a pressure of at least 60 psig to form the polyol. After formation, the polyol is utilized in a process of forming a polyurethane article. The process of forming the polyurethane article includes the steps of providing an isocyanate component and providing the polyol. The process of forming the polyurethane articles also includes the step of reacting the isocyanate component and the polyol to form the polyurethane article. The polyurethane article includes the reaction product of the isocyanate component and the polyol.

### FIELD OF THE INVENTION

The present invention generally relates to a process of forming a polyol, a process of forming a polyurethane article, and the polyurethane article. More specifically, the process of forming the polyol includes the step of reacting an initiator composition, a dimethylalkanolamine, and an alkylene oxide at a pressure of at least 60 psig.

### DESCRIPTION OF THE RELATED ART

Various processes of forming polyols are well known in the art and typically utilize metal catalysts and/or amine catalysts to catalyze formation of the polyols. The most common metal catalysts are potassium hydroxide and sodium hydroxide. Although very effective in catalyzing formation of polyols having functionalities of five or less, the metal catalysts have a tendency to prevent complete formation of polyols having functionalities of greater than five. Specifically, the metal catalysts negatively affect alkoxylation of initiator compositions including initiator compositions by alkylene oxides. The metal catalysts cause portions of the initiator compositions to remain unreacted thereby contaminating the polyols. Also, the polyols are formed in decreased yields resulting in increased chemical usage to compensate for the unreacted initiator compositions. This increases costs. Additionally, the metal catalysts must be removed from the polyols after formation as the metal catalysts also contaminate the polyols. This removal also increases costs and reduces production speed and efficiency.

Conversely, the amine catalysts such as trimethylamine and tributylamine are useful for forming the polyols having functionalities greater than five as the amine catalysts do not have a tendency to negatively affect the alkoxylation. Also, the amine catalysts do not have to be removed from the polyols after formation as they may beneficially remain in the polyols as catalysts if the polyols are subsequently reacted with isocyanates. However, the amine catalysts, typically impart offensive odors and volatile residues to the polyols and subsequent polyurethane articles. As such, the amine catalysts may be removed or neutralized to reduce the offensive odors and volatile residues. If the amine catalysts are not removed or neutralized and the polyols are used to form the polyurethane articles used in vehicles, then the volatile residues will remain and will contribute to windshield fogging and discoloration and degradation of polyvinyl chloride and polycarbonate vehicle components.

One process of forming polyols utilizing amine catalysts is disclosed in U.S. Pat. App. Pub. No. 2005/0004403 to Guttes et al. The '403 publication discloses a process of forming polyols by catalytic addition of alkylene oxides to initiator compositions using cycloaliphatic amines as catalysts. However, the cycloaliphatic amines do not readily react with the alkylene oxides to effect neutralization of the cycloaliphatic amines and reduce offensive odors and volatile residues. The cycloaliphatic amines react slowly with the alkylene oxides due to a large physical size of the rings, i.e., the steric hindrance of the rings and are also subject to a Hoffman elimination. Additionally, the process of the '403 publication does not utilize dimethylalkanolamines, which are less sterically hindered than the cycloaliphatic amines and at least partially react with the alkylene oxides. In fact, the stated goal of the '403 publication is to allow the cycloaliphatic amines to remain in the polyols to act catalytically in subsequent reactions of the polyols with the isocyanates. As such, the non-neutralized cycloaliphatic amines impart offensive odors to the polyols and leave volatile residues in the polyols. When used to form polyurethane articles used in vehicles, the volatile residues from the cycloaliphatic amines contribute to windshield fogging and discoloration and degradation of polyvinyl chloride and polycarbonate vehicle components.

Other processes of forming polyols utilizing amine catalysts are disclosed in Romanian Patent Numbers 85,853 and 118,432, both to Ionescu et al. The '853 patent discloses a process of forming polyether polyols by reacting sucrose and glycerin, a dimethylethanolamine, and propylene oxide at a temperature of from 110 to 120° C. and at a pressure of from 50 to 57 psig. Similarly, the '432 patent also discloses a process of forming polyether polyols by reacting sucrose, glycerin, a dimethylethanolamine, propylene oxide, and ethylene oxide. However, the process of the '432 patent includes reacting at a temperature of from 80 to 90° C. and an undisclosed pressure.

The reactions disclosed in the '853 patent and the '432 patent neutralize the dimethylethanolamine and reduce offensive odors and volatile residues. However, the reactions are not completed at high pressures, i.e., pressures of at least 60 psig, and are therefore slow, inefficient, and costly. The speed of the reactions in the '853 patent and the '432 patent allow the dimethylethanolamine to partially decompose. Partial decomposition of the dimethylethanolamine decreases reaction efficiency, increases amounts of the dimethylethanolamine that must be used, and increases costs. As such, the processes disclosed in the '853 and '432 patents are not optimized for industrial use.

Accordingly, there remains an opportunity to cost-effectively form a polyol that is substantially free of volatile residues imparted by an amine catalyst, does not impart a significant offensive odor to a polyurethane article, does not effectively contribute to windshield fogging, discoloration and degradation of polyvinyl chloride and polycarbonate vehicle components. There also remains an opportunity to form a polyurethane article from the polyol.

### SUMMARY OF THE INVENTION AND ADVANTAGES

The present invention provides a process of forming a polyol. The process includes the steps of providing an initiator composition, providing a dimethylalkanolamine, and providing an alkylene oxide. The process also includes the step of reacting the initiator composition, the dimethylalkanolamine, and the alkylene oxide at a pressure of at least 60 psig to form the polyol.

The process forms the polyol efficiently and cost-effectively as the dimethylalkanolamine is neutralized by at least partially reacting with the alkylene oxide. Therefore, the dimethylalkanolamine does not need to be removed from the polyol after formation to reduce offensive odors and/or volatile residues. As such, if the polyol is used to form polyurethane articles used in vehicles, the dimethylalkanolamine does not effectively contribute to windshield fogging and discoloration and degradation of polyvinyl chloride and polycarbonate vehicle components.

The present invention also provides the polyurethane article and a process of forming the polyurethane article. The polyurethane article includes the reaction product of an isocyanate component and the polyol formed from the process of the present invention. The process includes the steps of providing the isocyanate component, providing the polyol, and reacting the isocyanate component and the polyol to form the polyurethane article. The polyurethane article, like the polyol, does not have a significant offensive odor.

### DETAILED DESCRIPTION OF A PREFERRED EMBODIMENT

The present invention provides a process of forming a polyol. The process includes the step of providing an initiator composition and the step of providing a dimethylalkanolamine. The process also includes the step of providing an alkylene oxide and the step of reacting the initiator composition, the dimethylalkanolamine, and the alkylene oxide at a pressure of at least 60 psig to form the polyol. Each step is described in greater detail below.

Referring to the step of providing the initiator composition, the initiator composition preferably includes a first initiator having a functionality of at least six. In one embodiment, the first initiator is selected from the group of sucrose, sorbitol, and combinations thereof. Preferably, the first initiator includes sucrose, commercially available from Domino Foods Inc. However, it is also contemplated that an initiator having at least six hydroxyl groups such as a non-reducing sugar, other than sucrose, may also be used. It is also contemplated that combinations of the first initiator may be utilized.

In another embodiment, the initiator composition is substantially free of amines such that the polyol formed is not an amine based polyol. It is to be understood that substantially free, as related to the present invention, preferably includes an amount of amines in the initiator composition of less than 2, more preferably of less than 1, and most preferably of less than 0.5, parts by weight per 100 parts by weight of the initiator composition. In another embodiment, the initiator composition includes the first initiator consisting essentially of sucrose.

In yet another embodiment, the initiator composition includes a second initiator in addition to the first initiator. The second initiator may be any second initiator known in the art and may include low molecular weight di- and/or poly-functional alcohols. Preferably, the second initiator has a functionality of less than or equal to 3 and preferably has a hydroxyl number of at least 350 mg KOH/g. In one embodiment, the second initiator is selected from the group of glycerin, propylene glycol, di-propylene glycol, and combinations thereof. Most preferably, the second initiator has a functionality of 3 and a hydroxyl number of 1830 mg KOH/g and includes glycerin, commercially available from Proctor & Gamble under the trade name of Superol®. Other suitable second initiators include trimethylol-alkanes such as 1,1,1-trimethylolpropane. It is contemplated that combinations of the second initiators may also be utilized.

The first initiator and/or the second initiator may be present in the initiator composition in any amount. In one embodiment, the first initiator and the second initiator are present in the initiator composition in a ratio of 90:10 parts by weight of the first initiator to parts by weight of the second initiator. In another embodiment, the first initiator and the second initiator are present in the initiator composition in a ratio of 50:50 parts by weight of the first initiator to parts by weight of the second initiator. In yet another embodiment, the first initiator and the second initiator are present in the initiator composition in a ratio of 40:60 parts by weight of the first initiator to parts by weight of the second initiator.

The initiator composition may also include a second polyol, different from the first initiator and/or second initiator and different from the polyol of the present invention. The second polyol may be included in the initiator composition as a diluent to dissolve the first initiator and/or second initiator. If the second polyol is included, the second polyol preferably has a functionality of greater than 3 and a hydroxyl number of from 350 to 700 mg KOH/g.

The initiator composition may also include an anti-oxidant. If so, the anti-oxidant may be included in any amount, as selected by one skilled in the art. A particularly suitable antioxidant includes butylated hydroxytoluene (BHT).

Referring now to the step of providing the dimethylalkanolamine, the dimethylalkanolamine is preferably selected from the group of dimethylethanolamine, dimethylpropanolamine, and combinations thereof. As such, the dimethylalkanolamine preferably includes the general structure: 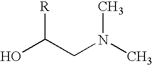
wherein R may be selected from the group of a hydrogen atom and a methyl group. If R is a hydrogen atom, the dimethylalkanolamine is dimethylethanolamine (i.e., dimethylaminoethanol.) If R is a methyl group, the dimethylalkanolamine is dimethylpropanolamine (i.e., 1-dimethylamino-2-propanol). Most preferably, R is hydrogen and the dimethylalkanolamine is dimethylethanolamine, commercially available from Atofina Chemicals, Inc of Philadelphia, Pa.

The step of providing the dimethylalkanolamine preferably includes the step of providing the dimethylalkanolamine in an amount of from 0.25 to 5, more preferably is from 0.5 to 3, and most preferably from 0.75 to 1.5, parts by weight per 100 parts by weight of the polyol. However, the dimethylalkanolamine may be provided in any amount so long as the dimethylalkanolamine is present in a catalytic amount and does not act in concert with the first initiator and/or second initiator to form an amine based polyol. The dimethylalkanolamine does react to some extent in a secondary reaction as described in “New Synthetic Pathways to Polyether Polyols for Rigid Polyurethane Foams” Ionescu, Mihail, et al. Advances in Urethane Science and Technology (1998), 14, 151-218. Yet, the secondary reaction does not form the amine based polyol.

Referring now to the step of providing the alkylene oxide, the alkylene oxide may be any alkylene oxide known in the art and is preferably selected from the group of ethylene oxide, propylene oxide, butylene oxide, amylene oxide, and combinations thereof. More preferably the alkylene oxide is selected from the group of ethylene oxide, propylene oxide, and combinations thereof. Most preferably, the alkylene oxide includes propylene oxide. The alkylene oxide may be provided in any amount dependent on the desires of one skilled in the art to form a specific polyol.

The reaction to form the polyol at the pressure of at least 60 psig is a ring opening alkoxylation reaction and forms chains of alkylene oxide units, i.e., blocks, on the hydroxyl groups of the first initiator and/or second initiator, thereby forming the polyol. In one embodiment, the polyol that is formed includes a block formed from the alkylene oxide. In another embodiment, the polyol includes two blocks formed from the alkylene oxide. In yet another embodiment, the polyol includes three or more blocks formed from the alkylene oxide. In one embodiment, the polyol includes internal blocks including at least one ethylene oxide unit and at least one propylene oxide unit arranged in a heteric formation, i.e., random addition of propylene oxide and/or ethylene oxide. In yet another embodiment, at a minimum, it is preferred that the blocks have 50 parts by weight of propylene oxide per 100 parts by weight of the polyol. Also, the heteric formation preferably includes less than or equal to 3 repeating propylene oxide units. After providing the initiator composition, the dimethylalkanolamine, and the alkylene oxide, the process may include the step of combining the initiator composition and the dimethylalkanolamine before reacting the initiator composition, the dimethylalkanolamine, and the alkylene oxide.

Although the initiator composition, the dimethylalkanolamine, and the alkylene oxide react at a pressure of at least 60 psig to form the polyol, the initiator composition, the dimethylalkanolamine, and the alkylene oxide preferably react at a pressure from 60 to 100, and more preferably from 60 to 90, and most preferably from 70 to 80, psig. It is also contemplated that the initiator composition, the dimethylalkanolamine, and the alkylene oxide may react at pressures greater than 100 psig, depending on the equipment available to those skilled in the art. It is believed that increasing pressure increases a speed of the reaction and minimizes decomposition of the dimethylalkanolamine thereby increasing efficiency of forming the polyol and reducing costs.

The initiator composition, the dimethylalkanolamine, and the alkylene oxide may react for any amount of time. Preferably, the initiator composition, the dimethylalkanolamine, and the alkylene oxide react for a time from 1 to 20, more preferably from 1 to 10, and most preferably from 3 to 7, hours. The initiator composition, the dimethylalkanolamine, and the alkylene oxide may also react at any temperature. Preferably, the initiator composition, the dimethylalkanolamine, and the alkylene oxide react at a temperature of 80° C. to 130° C., more preferably from 90° C. to 120° C., and most preferably from 100° C. to 110° C.

The polyol formed in the present invention may include, but is not limited to, polyether polyols. Most preferably, the polyol includes a polyether polyol. The polyol preferably has a hydroxyl number of less than or equal to 600, more preferably of from 250 to 500, and most preferably of from 350 to 470, mg KOH/g. Further, the polyol preferably has an equivalent weight of less than or equal to 200 Daltons. The terminology “equivalent weight” is a portion of the weight average molecular weight (M_{w}) of the polyol divided by a functionality of the polyol.

Preferably, the polyol is substantially free of volatile residues imparted by the dimethylalkanolamine. It is to be understood that substantially free, as related to the present invention, preferably includes an amount of the volatile residues in the polyol of less than 1, more preferably of less than 0.50, and most preferably of less than 0.05, parts by weight per 100 parts by weight of the polyol.

Also, the polyol preferably does not impart a significant offensive odor to a polyurethane article, described in greater detail below. The polyol also preferably does not effectively contribute to windshield fogging, discoloration and degradation of polyvinyl chloride and polycarbonate vehicle components, when the polyurethane article is used in vehicles. It is to be understood that the significant offensive odor and the effective contribution to the windshield fogging, discoloration, and degradation, are determined by one skilled in the art.

The present invention also provides a polyurethane article and a process of forming the polyurethane article. The polyurethane article includes the reaction product of an isocyanate component and the polyol. The process of forming the polyurethane article includes the steps of providing the isocyanate component and providing the polyol. The process also includes the step of reacting the isocyanate component and the polyol to form the polyurethane article.

After formation of the polyol and in preparation for formation of the polyurethane article, one or more additives may be added to the polyol and/or the isocyanate component. If included, the additive is preferably selected from the group of chain extenders, anti-foaming agents, processing additives, plasticizers, chain terminators, surface-active agents, adhesion promoters, flame retardants, anti-oxidants, water scavengers, fumed silicas, dyes, ultraviolet light stabilizers, fillers, thixotropic agents, polymerization catalysts, and combinations thereof. The additive may be included in the initiator composition any amount. Also, if the additive includes the anti-oxidant, the anti-oxidant added to the polyol and/or the isocyanate may be the same as or may be different from the anti-oxidant included in the initiator composition, first introduced above.

The isocyanate component that reacts with the polyol may be any isocyanate known in the art and may include, but is not limited to, isocyanates, polyisocyanates, biurets of isocyanates and polyisocyanates, isocyanurates of isocyanates and polyisocyanates, and combinations thereof. In one embodiment of the present invention, the isocyanate component includes an n-functional isocyanate. In this embodiment, n is a number preferably from 2 to 5, more preferably from 2 to 4, and most preferably from 2 to 3. It is to be understood that n may be an integer or may have intermediate values from 2 to 5. The isocyanate component may be selected from the group of aromatic isocyanates, aliphatic isocyanates, and combinations thereof. In one embodiment, the isocyanate component includes an aliphatic isocyanate. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

Alternatively, the isocyanate component may include an aromatic isocyanate. If the isocyanate component includes an aromatic isocyanate, the aromatic isocyanate may correspond to the formula R′(NCO)_{z} wherein R′ is a polyvalent organic radical which is aromatic and z is an integer that corresponds to the valence of R′. Preferably, z is at least two. If the isocyanate component includes the aromatic isocyanate, the isocyanate component may include, but is not limited to, the tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof.

The isocyanate component may have any % NCO content and any viscosity. The isocyanate component may also react with the polyol in any amount, as determined by one skilled in the art. Preferably, the isocyanate component and the initiator composition reacted at an isocyanate index of from 90 to 140, more preferably of from 95 to 130, and most preferably of from 100 to 120.

The polyurethane article may be a foam or may be an elastomer. Preferably, the polyurethane article is a rigid foam. If a rigid foam, the polyurethane article may be used in a wide variety of industries including, but not limited to, in insulation and in building and automotive supplies.

### EXAMPLES

Two polyols, Polyols 1 and 2, are formed according to the process of the present invention. Polyol 1 is formed by reacting an Initiator Composition, Dimethylethanolamine, and Propylene Oxide to form the Polyol 1. The Initiator Composition includes a first initiator including Sucrose and a second initiator including Glycerin. The Initiator Composition also includes a second polyol, Polyetherol 1, as a diluent. The Polyetherol 1 is different from the first initiator and/or second initiator and from the Polyols 1 and 2 of the present invention.

Specifically, to form the Polyol 1, the Glycerin and the Polyetherol 1 are added to a reactor and stirred at 150 rpm. A temperature of the reactor is then raised to 60° C. The Sucrose and the Dimethylethanolamine are then added to the reactor and the temperature of the reactor is further raised to 110° C. The Propylene Oxide is then consistently fed into the reactor to raise a pressure of the reactor to approximately 90 psig at 110° C. to begin to form the Polyol 1. The Propylene Oxide is then continually added to the reactor to maintain the pressure of the reactor of approximately 90 psig at 110° C. until completion of the reaction and completion of formation of the Polyol 1.

The Polyol 2 is also formed from reacting the Initiator Composition, the Dimethylethanolamine, and the Propylene Oxide. However, the Initiator Composition used to form Polyol 2 does not include the Polyetherol 1. The Polyol 2 is formed in the same way as the Polyol 1, as described above.

A comparative polyol, Comparative Polyol 1, is also formed but not by reacting the Initiator Composition, the Dimethylethanolamine, and the Propylene Oxide. The Comparative Polyol 1 is formed from reacting the Initiator Composition and the Propylene Oxide, in the presence of a metal catalyst, Potassium Hydroxide. There is no Dimethylethanolamine present in the formation of the Comparative Polyol 1. Also, the Initiator Composition used to form the Comparative Polyol 1 does not include the Polyetherol 1.

Specific amounts of the Initiator Composition, the Dimethylethanolamine, the Trimethylamine, the Potassium Hydroxide, and the Propylene Oxide, are set forth in Table 1, below. Formulation OH Numbers and Experimental OH Numbers of the Polyols 1 and 2 and the Comparative Polyol 1, are also set forth below, in Table 1. All components are in grams, unless otherwise indicated.

TABLE 1

| | | | Comparative |
|---|---|---|---|
| Initiator Composition | Polyol 1 | Polyol 2 | Polyol 1 |
| Glycerin | 630 | 76,000 | 1050 |
| Sucrose | 4300 | 152,000 | 3880 |
| Polyetherol 1 | 1450 | 0 | 0 |
| Dimethylethanolamine | 80 | 6,909 | 0 |
| Potassium Hydroxide | 0 | 0 | 100 |
| Propylene Oxide | 9350 | 716,800 | 10,800 |
| Formulation OH Number | 470 | 369 | 470 |
| (mg KOH/g) | | | |
| Experimental OH Number | 467 | 359 | 400* |
| (mg KOH/g) | | | |

*Approximately 25% of Sucrose is left unreacted

The Glycerin, commercially available from Proctor & Gamble under the trade name of Superol®, has a nominal functionality of 3 and a hydroxyl number of 1830 mg KOH/g.

The Sucrose, commercially available from Domino Foods Inc. has a nominal functionality of 8 and a hydroxyl number of 1312 mg KOH/g.

The Polyetherol 1, commercially available from BASF Corporation of Wyandotte, Mich., under the trade name of Pluracol® polyol GP 430, is a trifunctional polyol formed by adding propylene oxide to a glycerine nucleus. The Polyetherol 1 has a hydroxyl number of from 388 to 408 mg KOH/g, a nominal functionality of 3, and a nominal molecular weight of 400 g/mol.

The Dimethylethanolamine is commercially available from Atofina Chemicals, Inc. of Philadelphia, Pa.

The Potassium Hydroxide is commercially available from Air Products and Chemicals, Inc.

The Propylene Oxide is commercially available from Huntsman Base Chemicals.

The Formulation OH Number is the OH number (mg KOH/g) of each of the Polyols 1 and 2 and the Comparative Polyol 1 that is calculated to result from the reactions.

The Experimental OH Number is the OH number (mg KOH/g) of each of the Polyols 1 and 2 and the Comparative Polyol 1 that actually results from the reactions.

After formation, the Comparative Polyol 1 exhibits an Experimental OH Number that is within approximately 85 percent of the Formulation OH Number. Further, Polyols 1 and 2 exhibit Experimental OH Numbers that are within approximately 97 percent of the Formulation OH Numbers.

Accordingly, when compared to the Comparative Polyol 1 formed using the Potassium Hydroxide, the Polyols 1 and 2 are formed with a greater level of accuracy. Also, the Polyols 1 and 2 are formed cost effectively and with increased efficiency as compared to the Comparative Polyol 1. Additionally, the Polyols 1 and 2 do not impart a significant offensive odor to the polyurethane article and do not effectively contribute to windshield fogging, discoloration and degradation of polyvinyl chloride and polycarbonate vehicle components.

Obviously, many modifications and variations of the present invention are possible in light of the above teachings. The invention may be practiced otherwise than as specifically described within the scope of the appended claims.

What is claimed is:

1. A process of forming a polyol, said process comprising the steps of:
a) providing an initiator composition;
b) providing a dimethylalkanolamine;
c) providing an alkylene oxide; and
d) reacting the initiator composition, the dimethylalkanolamine, and the alkylene oxide at a pressure of at least 60 psig to form the polyol.

2. A process as set forth in claim 1 wherein the initiator composition is substantially free of amines.

3. A process as set forth in claim 1 wherein the initiator composition comprises a first initiator consisting essentially of sucrose.

4. A process as set forth in claim 1 wherein the initiator composition comprises a first initiator comprising sucrose.

5. A process as set forth in claim 4 wherein the initiator composition comprises a second initiator having a nominal functionality of less than or equal to 3 and a hydroxyl number of at least 350 mg KOH/g.

6. A process as set forth in claim 5 wherein the second initiator comprises glycerin.

7. A process as set forth in claim 6 wherein the first initiator and the second initiator are present in the initiator composition in a ratio of 90:10 parts by weight of the first initiator to parts by weight of the second initiator.

8. A process as set forth in claim 6 wherein the first initiator and the second initiator are present in the initiator composition in a ratio of 50:50 parts by weight of the first initiator to parts by weight of the second initiator.

9. A process as set forth in claim 6 wherein the first initiator and the second initiator are present in the initiator composition in a ratio of 40:60 parts by weight of the first initiator to parts by weight of the second initiator.

10. A process as set forth in claim 1 wherein the dimethylalkanolamine is selected from the group of dimethylethanolamine, dimethylpropanolamine, and combinations thereof.

11. A process as set forth in claim 1 wherein the dimethylalkanolamine comprises dimethylethanolamine.

12. A process as set forth in claim 1 wherein the step of providing the dimethylalkanolamine comprises the step of providing the dimethylalkanolamine in an amount of from 0.5 to 3 parts by weight based on 100 parts by weight of the polyol.

13. A process as set forth in claim 1 wherein the alkylene oxide is selected from the group of propylene oxide, ethylene oxide, butylene oxide, amylene oxide, and combinations thereof.

14. A process as set forth in claim 1 wherein the alkylene oxide comprises propylene oxide.

15. A process as set forth in claim 1 further comprising the step of combining the initiator composition and the dimethylalkanolamine before reacting the initiator composition, the dimethylalkanolamine, and the alkylene oxide.

16. A process as set forth in claim 1 wherein the step of reacting the initiator composition, the dimethylalkanolamine, and the alkylene oxide comprises reacting for a time of from 1 to 10 hours.

17. A process as set forth in claim 1 wherein the step of reacting the initiator composition, the dimethylalkanolamine, and the alkylene oxide comprises reacting at a temperature of from 90 to 120° C.

18. A process as set forth in claim 1 wherein the step of reacting the initiator composition, the dimethylalkanolamine, and the alkylene oxide comprises reacting at a pressure of from 60 to 90 psig.

19. A process as set forth in claim 1 wherein the polyol has a hydroxyl number of from 250 to 500 mg KOH/g.

20. A process as set forth in claim 1 wherein the initiator composition is substantially free of amines and comprises a first initiator comprising sucrose and a second initiator comprising glycerin, the dimethylalkanolamine comprises dimethylethanolamine, the step of providing the dimethylalkanolamine comprises the step of providing the dimethylalkanolamine in an amount of from 0.5 to 3 parts by weight based on 100 parts by weight of the polyol, the alkylene oxide comprises propylene oxide, the step of reacting the initiator composition, the dimethylalkanolamine, and the alkylene oxide further comprises reacting for a time of from 1 to 10 hours, at a temperature of from 90 to 120° C., and at a pressure of from 60 to 90 psig, and the polyol has a hydroxyl number of from 250 to 500 mg KOH/g.

21. A process of forming a polyurethane article comprising the steps of:
a) providing an isocyanate component;
b) providing a polyol formed from a process comprising the steps of;
1) providing an initiator composition,
2) providing a dimethylalkanolamine,
3) providing an alkylene oxide, and
4) reacting the initiator composition, the dimethylalkanolamine, and the alkylene oxide at a pressure of at least 60 psig to form the polyol; and
c) reacting the isocyanate component and the polyol to form the polyurethane article.

22. A process as set forth in claim 21 wherein the initiator composition is substantially free of amines.

23. A process as set forth in claim 21 wherein the initiator composition comprises a first initiator consisting essentially of sucrose.

24. A process as set forth in claim 21 wherein the initiator composition comprises a first initiator comprising sucrose.

25. A process as set forth in claim 24 wherein the initiator composition comprises a second initiator comprising glycerin.

26. A process as set forth in claim 21 wherein the dimethylalkanolamine comprises dimethylethanolamine.

27. A process as set forth in claim 21 wherein the step of providing the dimethylalkanolamine comprises the step of providing the dimethylalkanolamine in an amount of from 0.5 to 3 parts by weight based on 100 parts by weight of the polyol.

28. A process as set forth in claim 21 wherein the alkylene oxide comprises propylene oxide.

29. A process as set forth in claim 21 wherein the step of reacting the initiator composition, the dimethylalkanolamine, and the alkylene oxide further comprises reacting for a time of from 1 to 10 hours, at a temperature of from 90 to 120° C., and at a pressure of from 60 to 90 psig.

30. A process as set forth in claim 21 wherein the polyol has a hydroxyl number of from 250 to 500 mg KOH/g.

31. A process as set forth in claim 21 wherein the polyurethane article comprises a foam.

32. A process as set forth in claim 21 wherein the step of reacting the isocyanate component and the polyol comprises the step of reacting the isocyanate component and the polyol at an isocyanate index of from 95 to 130.

33. A process as set forth in claim 21 wherein the initiator composition is substantially free of amines, the initiator composition comprises a first initiator comprising sucrose and a second initiator comprising glycerin, the dimethylalkanolamine comprises dimethylethanolamine, the step of providing the dimethylalkanolamine comprises the step of providing the dimethylalkanolamine in an amount of from 0.5 to 3 parts by weight based on 100 parts by weight of the polyol, the alkylene oxide comprises propylene oxide, the step of reacting the initiator composition, the dimethylalkanolamine, and the alkylene oxide further comprises reacting for a time of from 1 to 10 hours, at a temperature of from 90 to 120° C., and at a pressure of from 60 to 90 psig, and the polyol has a hydroxyl number of from 250 to 500 mg KOH/g.

34. A polyurethane article comprising the reaction product of:
a) an isocyanate component; and
b) a polyol comprising the reaction product of:
1) an initiator composition,
2) a dimethylalkanolamine, and
3) an alkylene oxide, wherein the reaction of the initiator composition, the dimethylalkanolamine, and the alkylene oxide is at a pressure of at least 60 psig.

35. A polyurethane article as set forth in claim 34 wherein said initiator composition is substantially free of amines.

36. A process as set forth in claim 34 wherein said initiator composition comprises a first initiator consisting essentially of sucrose.

37. A polyurethane article as set forth in claim 34 wherein said initiator composition comprises a first initiator comprising sucrose.

38. A polyurethane article as set forth in claim 37 wherein said initiator composition comprises a second initiator comprising glycerin.

39. A polyurethane article as set forth in claim 34 wherein said dimethylalkanolamine comprises dimethylethanolamine.

40. A polyurethane article as set forth in claim 34 wherein the dimethylalkanolamine is present in an amount of from 0.5 to 3 parts by weight based on 100 parts by weight of the polyol.

41. A polyurethane article as set forth in claim 34 wherein said alkylene oxide comprises propylene oxide.

42. A polyurethane article as set forth in claim 34 wherein the reaction of the initiator composition, the dimethylalkanolamine, and the alkylene oxide is for a time of from 1 to 10 hours, at a temperature of from 90 to 120° C., and at a pressure of from 60 to 90 psig.

43. A polyurethane article as set forth in claim 34 wherein said polyol has a hydroxyl number of from 250 to 500 mg KOH/g.

44. A polyurethane article as set forth in claim 34 wherein said polyurethane article comprises a foam.

45. A process as set forth in claim 34 wherein the reaction of the isocyanate component and the polyol is at an isocyanate index of from 95 to 130.

46. A polyurethane article as set forth in claim 34 wherein said initiator composition is substantially free of amines, said initiator composition comprises a first initiator comprising sucrose and a second initiator comprising glycerin, said dimethylalkanolamine comprises dimethylethanolamine, the dimethylalkanolamine is present in an amount of from 0.5 to 3 parts by weight based on 100 parts by weight of the polyol, said alkylene oxide comprises propylene oxide, the reaction of the initiator composition, the dimethylalkanolamine, and the alkylene oxide is for a time of from 1 to 10 hours, at a temperature of from 90 to 120° C., and at a pressure of from 60 to 90 psig, and said polyol has a hydroxyl number of from 250 to 500 mg KOH/g.
